(19) United States
(12) Patent Application Publication
(10) Pub. No.: US 2021/0346824 A1
(43) Pub. Date: Nov. 11, 2021

(54) Regenerative Media Filtration Apparatus Improvements

(71) Applicant: Evoqua Water Technologies LLC, Pittsburgh, PA (US)

(72) Inventor: Sean J. Curley, Denver, NC (US)

(73) Assignee: Evoqua Water Techhnologies LLC, Pittsburgh, PA (US)

(21) Appl. No.: 17/230,976

(22) Filed: Apr. 14, 2021

Related U.S. Application Data
(60) Provisional application No. 63/009,077, filed on Apr. 13, 2020.

(51) Int. Cl. B01D 24/16; B01D 24/46; B01D 29/15; B01D 29/52; B01D 29/66; C02F 1/00

(52) U.S. Cl. CPC B01D 24/16; B01D 24/4621; B01D 29/15; C02F 2103/42; B01D 29/66; C02F 1/004; B01D 29/52

(57) ABSTRACT

A regenerative media filter vessel is provided. The regenerative media filter vessel includes a first inlet, a first outlet, and a tube sheet comprising a plurality of tube elements. A portion of the tube element is disposed within a frame positioned about a periphery of tube element and configured to prevent contact between adjacent tube elements. Also disclosed is a method of facilitating water filtration using a regenerative media filter vessel. The method includes providing a regenerative media filter vessel of this disclosure. The method further includes providing the particulate media.

### CROSS-REFERENCE TO RELATED APPLICATIONS

This application claims priority under 35 U.S.C. § 119(e) to U.S. Provisional Application Ser. No. 63/009,077, titled “Regenerative Media Filtration Apparatus Improvements” filed Apr. 13, 2020, which is incorporated herein by reference in its entirety for all purposes.

### FIELD OF TECHNOLOGY

Aspects and embodiments disclosed herein are generally directed to water treatment systems, and more specifically, to water treatment systems for use in aquatics or recreational facilities and methods of facilitating same.

### SUMMARY

In accordance with an aspect, there is provided a regenerative media filter vessel. The regenerative media filter vessel may include a first inlet fluidly connectable to a feed source comprising water to be filtered. The regenerative media filter vessel further may include a first outlet fluidly connectable to an end use configured to discharge filtered water. The regenerative media filter vessel additionally may include a tube sheet comprising a plurality of tube elements. Each of the plurality of tube elements may have a first end fixedly connected to the tube sheet and a second end. At least a portion of the tube element may be disposed within a frame positioned about a periphery of the tube element and configured to prevent contact between adjacent tube elements within the regenerative media filter vessel.

In some embodiments, the frame may include a structure having an inner dimension sized to permit a tube element to pass and allow for fluid to flow freely while providing a boundary around the periphery of the portion of the plurality of tube elements.

In some embodiments, the frame may be disposed near the first end of the tube element. In particular embodiments, wherein the frame may be fixedly connected to a same location as the first ends of the tube element.

In some embodiments, the frame may be disposed near the second end of the tube element. In particular embodiments, the frame may be disposed between the first end and the second end of the tube element.

In some embodiments, a portion of the plurality of tube elements may include at least one frame disposed about their periphery.

In certain embodiments, the structure may be a helix having an inner diameter sized to permit an interference fit between the tube element and the frame. The helix may have an outer diameter sized to provide a boundary sufficient to prevent contact between adjacent tube elements.

In certain embodiments, the structure may be a plurality of plates having an aperture therethrough sized to permit an interference fit between the tube element and the plurality of plates. In particular embodiments, the plurality of plates may be positioned orthogonally along a length of the tube element and connected by a plurality of connecting members disposed parallel to the tube element. Each of the plurality of plates may have an outer dimension sized to provide a boundary sufficient to prevent contact between adjacent tube elements.

In some embodiments, the frame is manufactured from a material selected from the group consisting of stainless steel, aluminum, polypropylene (PP), polyvinyl chloride (PVC), polytetrafluoroethylene (PTFE), and combinations thereof.

In further embodiments, the regenerative media filter vessel may include a second inlet fluidly connectable to a first source of gas and a gas distributor fluidly connected to the second inlet, the gas distributor positioned below the plurality of tube elements.

In further embodiments, the regenerative media filter vessel may include an inflatable bladder operatively connected to the tube sheet and configured to mechanically agitate the tube sheet within the regenerative media filter vessel upon inflation and deflation.

In accordance with an aspect, there is provided a method of facilitating water filtration using a regenerative media filter vessel. The method may include providing the regenerative media filter vessel. The provided regenerative media filter vessel may include a first inlet fluidly connectable to a feed source comprising water to be filtered, a first outlet fluidly connectable to an end use configured to discharge filtered water, and a tube sheet comprising a plurality of tube elements where each of the plurality of tube elements having first ends fixedly connected to the tube sheet and second ends. At least a portion of the tube element may be disposed within a frame positioned about a periphery of the tube element and configured to prevent contact between adjacent tube elements. The method further may include instructing a user to fluidly connect the first inlet to a feed source. The method additionally may include instructing a user to fluidly connect the first outlet to an end use configured to receive filtered water.

In further embodiments, the method may include providing the particulate media.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a technical diagram of a regenerative media filter vessel, according to one embodiment;

FIG. 2 illustrates a helical frame for a tube element, according to one embodiment; and

FIG. 3 illustrates a plate-based frame for a tube element, according to one embodiment.

### DETAILED DESCRIPTION

Systems and methods for treatment of water for use in aquatics and recreational facilities are disclosed herein. The systems and methods may provide filtration of the aquatic and/or recreational water by treatment with a regenerative media filter. Regenerative media filters typically function as particle removal filters by using a structure, for example, a porous structure, on which a medium may be coated. For example, a regenerative media filter may comprise a tube sheet containing a plurality of porous tube elements and a perlite or diatomaceous earth (DE) media.

Regenerative media filters generally employ a special grade medium to treat water. The special grade medium may be contained in a vessel or other container. The regenerative media filter may be a pressure-fed or high-rate media filter. During filtration, the water to be treated may be fed to the regenerative media filter vessel, for example, by one or more pumps. Inside the regenerative media filter vessel, the water may be distributed by a water distribution head before coming into contact with the special grade medium in the vessel. Generally, the special grade medium acts as a substrate and catches solid contaminants contained in the water. The filtered water is discarded from the regenerative media filter vessel and may be returned to the source for further use in the aquatic or recreational facility. The regenerative media filter vessel may include one or more vents that can be opened manually or automatically to regulate pressure within the regenerative media filter vessel during one or more modes of operation.

In accordance with certain embodiments, the media filter may be a regenerative media filter, an activated carbon filter, or a walnut shell filter. The media filter may comprise any suitable particulate media for filtering aquatic and/or recreational water. The media filter may comprise perlite or DE media. In some embodiments, the media filter may be, for example, a DEFENDER® media filter (distributed by Evoqua Water Technologies LLC, Pittsburgh, Pa.).

In some embodiments, the regenerative media filter vessel may include a first inlet fluidly connectable to a feed source comprising water to be filtered, a first outlet fluidly connectable to an end use configured to discharge filtered water, and a tube sheet comprising a plurality of tube elements. Each of the plurality of tube elements may have a first end fixedly connected to the tube sheet and a second end. In some embodiments, at least a portion of the plurality of tube elements may be disposed within a frame positioned about a periphery of the portion of the plurality of tube elements. The frame around each of the portion of the plurality of tube elements may be configured to prevent contact between adjacent tube elements within the regenerative media filter vessel.

The regenerative media filter vessel may include a plurality of tube elements coated with a filtration media. For example, the tube elements may comprise polymer tubes, optionally porous polymer tubes. The plurality of tube elements may be arranged on the tube sheet, for example, concentrically. In some embodiments, the tube elements may comprise a metal, such as stainless steel. Media filters of the coated tube element type are described in PCT/US2019/062373 filed Nov. 20, 2019, titled “REGENERATIVE MEDIA FILTER AIR SCOURING APPARATUS AND METHOD,” PCT/US2019/056850 filed Oct. 18, 2019 titled “REGENERATIVE MEDIA FILTER AND RELATED METHODS,” and WO 2019/055903 filed Sep. 17, 2018 titled “SAND FILTER LED STATUS LIGHT,” all to Evoqua Water Technologies LLC, Pittsburgh, Pa., the disclosures of which are herein incorporated by reference in their entirety for all purposes.

In use, the porous tube elements may be coated with perlite or DE. In such an embodiment, the porous tubes tube elements may be used to prevent the substrate from passing into the filtrate of the media filter. Once coated, the water to be treated may pass through the coating and then through the tube elements. The coating layer may provide for very fine filtration media, such that the regenerative media filter vessel may filter liquids to a small particle size. In some embodiments, the regenerative media filter vessel may be configured to filter liquids to less than 10 μm. The regenerative media filter vessel may be configured to filter liquids to less than about 10 μm, less than about 5 μm, less than about 3 μm, or less than about 1 μm. The regenerative media filter vessel of this disclosure may include the media to be coated onto the plurality of tube elements.

The regenerative media filter vessel may generally be connectable, and in use fluidly connected, to a source of water. For example, the regenerative media filter vessel may be used as part of a water treatment system for treating water for use in aquatics or recreational facilities. The water filtration system may comprise a media filter vessel connectable to a source of water. The water filtration system may comprise one or more lines, pipes, valves, or pumps positioned to distribute the water within the system and optionally to return the treated water to the aquatic or recreational facility after treatment. In some embodiments, regenerative media filter vessel of the invention may include connections for gas lines configured to distribute pressurized gases, such as compressed air, to one or more pneumatic components of the regenerative media filter vessel.

In some embodiments, the water to be treated may include water for human or veterinary applications. For example, the water may be used for recreational purposes, such as swimming. The water may be associated with a pool, spa, hot tub, water park, water fountain, aquarium, zoo, animal reserve, and the like. Typically, the regenerative media filter vessel may be positioned in the vicinity of the source of the water. In some embodiments, the regenerative media filter vessel may be remote from the source of the aquatic and/or recreational water.

The water to be treated may have a concentration of organic contaminants. In some embodiments, the organic contaminants may include one or more of animal waste, food particles, and foreign matter such as mold, mildew, moss, and/or algae.

While embodiments described herein generally refer to aquatic and recreational facilities water, such an application is exemplary. It should be understood that the systems and methods disclosed may be employed for filtration of any fluid to be filtered with a particulate media filter. For instance, systems and methods disclosed herein may be employed for filtration of potable water, aquaculture, irrigation, stormwater management, water for use of oil and gas processing, and other applications.

The regenerative media filter vessel may be of a size suitable for processing between 70 and 2500 gallons per minute (GPM) of water. For example, the regenerative media filter vessel may be sized to process between about 70 GPM and about 100 GPM, between about 100 GPM and about 250 GPM, between about 250 GPM and about 500 GPM, between about 500 GPM and about 1000 GPM, between about 1000 GPM and about 2000 GPM, or between about 2000 GPM and about 2500 GPM. The regenerative media filter may comprise more than one vessel, arranged in series or in parallel. Generally, the size and arrangement of regenerative media filter vessels may vary with the size of aquatic or recreational structure to be filtered.

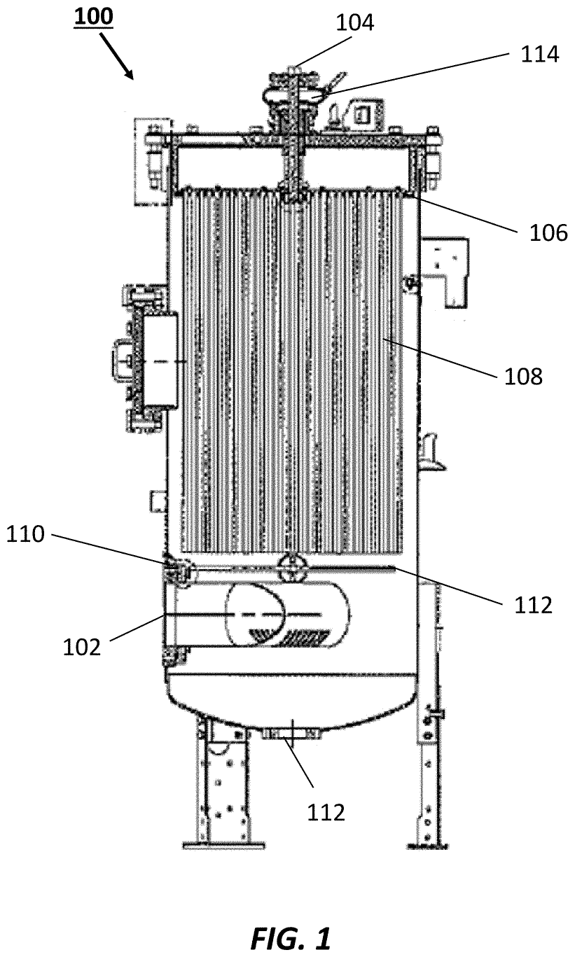

FIG. 1 shows a vertical cross-section of a regenerative media filter vessel 100. The regenerative media filter vessel 100 includes an inlet 102 to allow water to be treated to enter the regenerative media filter vessel 100 and an outlet 104 to allow treated water to exit the regenerative media filter vessel 100. The regenerative media filter vessel 100 houses a tube sheet 106 comprising a plurality of tube elements 108. Positioned below the plurality of tube elements 108 is a second inlet 110 fluid and a gas distributor 112 fluidly connected to the second inlet 110. Gas distributor 112 may be configured to deliver a plurality of bubbles into the regenerative media filter vessel 100 to aid in a maintenance process performed on the regenerative media filter vessel 100. The regenerative media filter vessel 100 further includes a drain 112 configured to drain the water, particulate media, and contaminants from the regenerative media filter vessel 100 when open.

With continued reference to FIG. 1, and in some embodiments, the tube sheet 106 is connected to inflatable bladder 114. In this configuration, the tube sheet 106 and plurality of tube elements 108 may be mechanically moved within the regenerative media filter vessel 100 upon inflation and deflation of the inflatable bladder 114.

In some embodiments, at least a portion of a tube element may be disposed within a frame positioned about a periphery of the tube element. The frame may be configured, i.e., positioned, in such a manner as to prevent contact between adjacent tube elements of the plurality of tube elements. Without wishing to be bound by any particular theory, contact between tube elements within the regenerative media filter vessel may remove filter media that has been deposited on the outer surface of the tube elements, reducing filtration performance. A portion, as used herein, includes at least one of the plurality of tube elements and may include any number of the plurality of tube elements, including all of the plurality of tube elements. In general, one frame may be associated with one tube element. This is not limiting, and a tube element may include more than one frame, e.g., a plurality of frames, disposed around its periphery along the length of the tube element. In other embodiments, a portion, i.e., more than one, of the plurality of tube elements may include at least one frame connected at its periphery. One of skill in the art would readily be able to determine if a tube element needed a plurality of frames or if more than one tube element of the plurality of tube elements needed at least one frame about their periphery in order to maintain the integrity of the media coating on the tube element(s).

The frame may be fixedly connected at any practical location along a length of the tube element to which it is connected. For example, the frame may be disposed near the first end of a tube element, i.e., where a tube element is fixedly connected to the tube sheet of the regenerative media filter vessel. Alternatively, the frame may be disposed near the second end of a tube element; with reference to FIG. 1, the second end of the tube element is disposed near the inlet 102. In other embodiments, the frame may be disposed at any position between the first ends and the second ends of the tube element. In some embodiments, when more than one tube element of the plurality of tube elements includes a frame, each frame may be disposed near the first ends of the tube elements, the second ends of the tube elements, or at locations disposed between the first ends and second ends of the tube elements. Alternatively, when more than one tube element of the plurality of tube elements includes a frame, each frame may be disposed in different locations, i.e., some tube elements may have a frame disposed near the first ends of the tube elements, some of the tube elements may have a frame disposed near the second ends of the tube elements, or some of the tube elements may have a fame disposed at locations between the first ends and second ends of the tube elements. The invention of this disclosure is not limited by the locations of the frames, and one of skill in the art would be able to determine where the frame or a plurality of frames should be positioned on the tube element or plurality of tube elements within the regenerative media filter vessel.

In some embodiments, the frame includes a structure having an inner dimension sized to permit a tube element to pass and allow for fluid to flow freely while providing a boundary around the periphery of the tube element. The structure of the frame may be of any practical shape that can provide for a boundary around the periphery of the tube element. For example, in some non-limiting embodiments, the inner dimension of the frame may be generally circular to correspond to the generally circular shape of the tube element. The circular shape of the tube element, and the corresponding shape of the inner dimension of the frame, is exemplary and other shapes are envisioned by this disclosure.

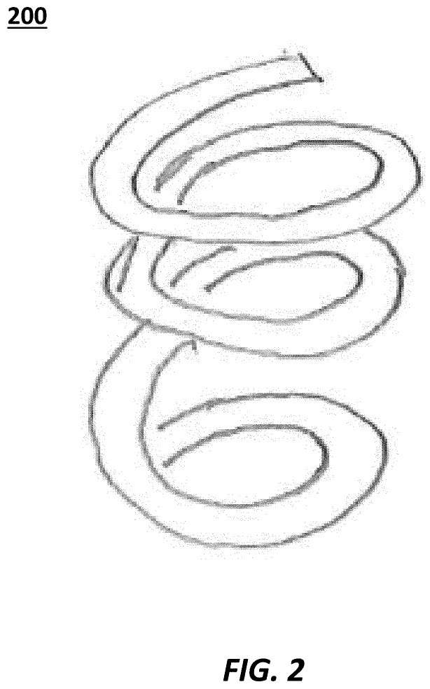

In some embodiments, the structure of the frame may be a helix having an inner diameter sized to permit an interference, i.e., friction, fit between the tube element and the frame. An embodiment of a helical frame for positioning about the periphery of the tube element is illustrated in FIG. 2. For example, the helix may have a uniform inner diameter along its length such that substantially all of the inner surfaces of the helix contact the periphery of the tube element. Alternatively, the helix may have a non-uniform inner diameter along its length, i.e., a taper, provided that the smallest inner diameter of the helix is sized to permit the interference fit between the helix and the periphery of the tube element as described herein. In still other embodiments, the helix may have a non-uniform inner diameter which undulates along its length, akin to a sine wave. In this configuration, the troughs of the undulating pattern may be sized to permit the interference fit between the helix and the periphery of the tube element as described herein. In general, the length of the helix may be any practical length, and this invention is not limited by the length of the helix.

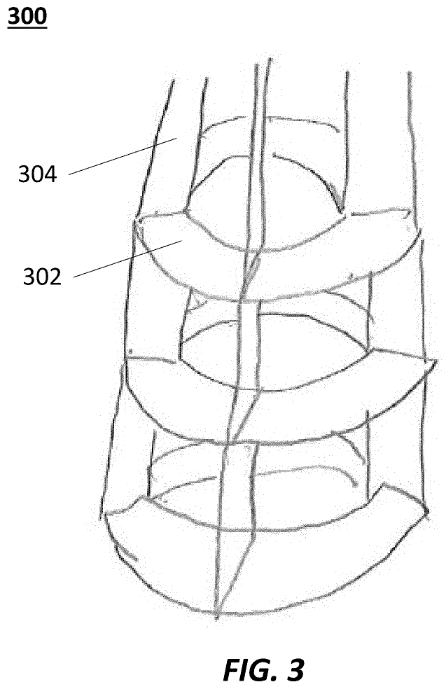

In some embodiments, the structure of the frame may include a plurality of plates having an aperture therethrough sized to permit an interference fit between the tube element and the plurality of plates. In this configuration, the plurality of plates positioned orthogonally along a length of the tube element. The orthogonally positioned plates may be connected at their periphery by a plurality of connecting members disposed parallel to the tube element. An embodiment of a frame including a plurality of plates and connecting members is illustrated in FIG. 3. With reference to FIG. 3, frame 300 may include a plurality of plates 302 having an aperture therethrough that are vertically oriented orthogonal to where a tube element would pass through the apertures. The plates 302 are connected at their periphery by connecting members 304 disposed parallel to where a tube element would pass through the apertures and orthogonal to the plates 302. As illustrated, the frame 300 includes three plates 302 and three connecting member 304. This is only an embodiment, and a frame constructed in this manner may include any number of plates and any number of connecting members. For example, each of the plurality of plates of the frame may have the same outer diameter, i.e., forming a generally cylindrical frame. Alternatively, each of the plurality of plates of the frame may have a different outer diameter, with the arrangement providing for a tapering of the outer diameters. As a specific example, for a plurality of plates each having a different outer diameter, the plurality of plates may be arranged to provide for a uniform taper, i.e., smallest to largest or vice-versa, as positioned on the periphery of the tube element. In still other embodiments, the plurality of plates may be arranged having different outer diameter plates arranged in any practical pattern along the length of the frame, e.g., undulating pattern, with the connecting member having a corresponding shape as the chosen pattern for connecting the plurality of plates. In general, the length of the frame, in part defined by the number of the plurality of plates and the length of the connecting members connecting the plurality of plates, may be any practical length, and this invention is not limited by the length of the frame. The invention of this disclosure is further not limited by the number of the plurality of plates constituting the frame nor the spacing between each of the plurality of plates, provided the number and spacing are sufficient for water within the regenerative media filter vessel to freely pass.

In some embodiments, the frame may provide for a boundary around the periphery of the tube element. For example, the frame may provide for a boundary of about 0.25 inches to about 1 inch of boundary about the periphery of a tube element, e.g., about 0.25 inches, about 0.375 inches, about 0.50 inches, about 0.625 inches, about 0.75 inches, about 0.875 inches, or about 1 inch of boundary about the periphery of a tube element. Each frame disposed about the periphery of a tube element may be sized to provide the same, i.e., a uniform, boundary about the about the periphery of a tube element. Alternatively, each frame disposed about the periphery of a tube element may be sized to provide a different, i.e., non-uniform boundary about the about the periphery of the tube element to which it is are attached. The invention of this disclosure is not limited in the size of the boundary provided by the frame attached to the plurality of tube elements, and one of skill in the art would be able to determine the necessary boundary provided by a frame for a specific application.

The frame may be manufactured from a material which is designed for immersion in water while maintaining structural rigidity. The material for the frame should be resistant to water damage or corrosion due to the composition of the water being treated, i.e., pH, total dissolved solids content, or ionic composition. The material should also not permit the particulate filter media to adhere and aggregate of the surfaces of the frame which may reduce flow of water through the tube elements at the location where the frame is connected. In some embodiments, the frame may be manufactured from a material selected from the group consisting of stainless steel, aluminum, polypropylene (PP), polyvinyl chloride (PVC), polytetrafluoroethylene (PTFE), and combinations thereof. Alternatively, or in addition, the material of the frame may include a coating of a non-stick type, such as PTFE or another suitable material, to reduce filter media aggregation on the surfaces of the frame. The aforementioned materials are only embodiments, and this disclosure envisions a frame manufactured from any suitable material or likewise coated in any suitable material which would be known to one of skill in the art to provide the necessary reduction in aggregation of particulate media onto the frame.

In accordance with an aspect, there is provided a method of facilitating water filtration using a regenerative media filter vessel. The method may include providing the regenerative media filter vessel. The provided regenerative media filter vessel may include a first inlet fluidly connectable to a feed source comprising water to be filtered, a first outlet fluidly connectable to an end use configured to discharge filtered water; and a tube sheet comprising a plurality of tube elements. Each of the plurality of tube elements may have first ends fixedly connected to the tube sheet and second ends. At least a portion of the tube element may be disposed within a frame positioned about a periphery of the tube element. The frame may be configured to prevent contact between adjacent tube elements within the regenerative media filter vessel. The method may further include instructing a user to fluidly connect the first inlet to a feed source. The method may additionally include instructing a user to fluidly connect the first outlet to an end use configured to receive filtered water.

In further embodiments, the method may include providing the particulate media.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. A regenerative media filter vessel, comprising:
a first inlet fluidly connectable to a feed source comprising water to be filtered;
a first outlet fluidly connectable to an end use configured to discharge filtered water; and
a tube sheet comprising a plurality of tube elements, each of the plurality of tube elements having a first end fixedly connected to the tube sheet and a second end, at least a portion of the tube element disposed within a frame positioned about a periphery of the tube element and configured to prevent contact between adjacent tube elements.

2. The filter vessel of claim 1, wherein the frame includes a structure having an inner dimension sized to permit a tube element to pass and allow for fluid to flow freely while providing a boundary around the periphery of the portion of the plurality of tube elements.

3. The filter vessel of claim 1, wherein the frame is disposed near the first end of the tube element.

4. The filter vessel of claim 3, wherein the frame is fixedly connected to a same location as the first end of the tube element.

5. The filter vessel of claim 1, wherein the frame is disposed near the second end of the tube element.

6. The filter vessel of claim 1, wherein the frame is disposed between the first end and the second end of the tube element.

7. The filter vessel of claim 2, wherein the structure is a helix having an inner diameter sized to permit an interference fit between the tube element and the frame.

8. The filter vessel of claim 7, wherein the helix has an outer diameter sized to provide a boundary sufficient to prevent contact between adjacent tube elements.

9. The filter vessel of claim 2, wherein the structure is a plurality of plates having an aperture therethrough sized to permit an interference fit between the tube element and the plurality of plates, the plurality of plates positioned orthogonally along a length of the tube element and connected by a plurality of connecting members disposed parallel to the tube element.

10. The filter vessel of claim 9, wherein each of the plurality of plates has an outer dimension sized to provide a boundary sufficient to prevent contact between adjacent tube elements.

11. The filter vessel of claim 1, wherein the frame is manufactured from a material selected from the group consisting of stainless steel, aluminum, polypropylene, polyvinyl chloride, polytetrafluoroethylene, and combinations thereof.

12. The filter vessel of claim 1, further comprising a second inlet fluidly connectable to a first source of gas and a gas distributor fluidly connected to the second inlet, the gas distributor positioned below the plurality of tube elements.

13. The filter vessel of claim 1, further comprising an inflatable bladder operatively connected to the tube sheet and configured to mechanically agitate the tube sheet within the regenerative media filter vessel upon inflation and deflation.

14. A method of facilitating water filtration using a regenerative media filter vessel, comprising:
providing the regenerative media filter vessel, the regenerative media filter vessel comprising:
a first inlet fluidly connectable to a feed source comprising water to be filtered;
a first outlet fluidly connectable to an end use configured to discharge filtered water; and
a tube sheet comprising a plurality of tube elements, each of the plurality of tube elements having a first end fixedly connected to the tube sheet and a second end, at least a portion of the tube element disposed within a frame positioned about a periphery of the tube element and configured to prevent contact between adjacent tube elements;
instructing a user to fluidly connect the first inlet to a feed source; and
instructing a user to fluidly connect the first outlet to an end use configured to receive filtered water.

15. The method of claim 14, further comprising providing the particulate media.
